(19) United States
(12) Patent Application Publication
(10) Pub. No.: US 2025/0348246 A1
(43) Pub. Date: Nov. 13, 2025

(54) MEMORY DEVICE, METHOD OF OPERATING THE SAME, AND MEMORY SYSTEM INCLUDING THE MEMORY DEVICE

(71) Applicant: SAMSUNG ELECTRONICS CO., LTD., Suwon-si (KR)

(72) Inventors: Seungki HONG, Suwon-si (KR); Hoseok Seol, Suwon-si (KR); Ki-Heung Kim, Suwon-si (KR); Wonho Choi, Suwon-si (KR); Jinyong Choi, Suwon-si (KR)

(73) Assignee: SAMSUNG ELECTRONICS CO., LTD., Suwon-si (KR)

(21) Appl. No.: 19/007,158

(22) Filed: Dec. 31, 2024

(30) Foreign Application Priority Data
May 10, 2024 (KR) 10-2024-0062116

(51) Int. Cl. G06F 3/06

(52) U.S. Cl. CPC G06F 3/0659; G06F 3/0604; G06F 3/0673

(57) ABSTRACT

A memory device may include: a command decoder configured to obtain a command; a timer configured to measure an operation time of an idle mode based on the idle mode being entered according to the command; and a control circuit configured to: compare the operation time and a reference time; and control a state of a power control operation for at least one semiconductor device in the idle mode based on a result of the comparing.

### CROSS-REFERENCE TO RELATED APPLICATION

This application claims the benefit of Korean Patent Application No. 10-2024-0062116, filed on May 10, 2024, in the Korean Intellectual Property Office, the disclosure of which is incorporated herein by reference.

### BACKGROUND

### 1. Field of the Invention

Example embodiments relate to a memory device, a method of operating the same, and a memory system including the memory device.

### 2. Description of the Related Art

A memory device may be divided broadly into a volatile memory device and a non-volatile memory device. While the volatile memory device has a high speed of reading and writing, but stored contents therein disappear when a power supply is stopped, the non-volatile memory device may preserve the contents even though the power supply is stopped. In order to reduce power consumption in various systems where these memory devices are applied, a technology for efficiently controlling the power consumption of a memory device is desired.

### SUMMARY

Various aspects provide a memory device, a method of operating the same, and a memory system including the memory device for efficiently controlling the power consumption of the memory device.

The present disclosure is not limited to the technical features described above, and other technical features may be inferred from the example embodiments below.

According to one or more example embodiments, a memory device may include: a command decoder configured to obtain a command; a timer configured to measure an operation time of an idle mode based on the idle mode being entered according to the command; and a control circuit configured to: compare the operation time and a reference time; and control a state of a power control operation for at least one semiconductor device in the idle mode based on a result of the comparing.

According to one or more example embodiments, a method of operating a memory device, may include: obtaining a command for entering an idle mode; measuring an operation time of the idle mode based on the idle mode being entered; and comparing the operation time and a reference time and controlling a state of a power control operation for at least one semiconductor device in the idle mode based on a result of comparison.

According to one or more example embodiments, a memory system may include: a memory device; and a memory controller configured to control the memory device, wherein the memory device comprises: a command decoder configured to obtain a command; based on an idle mode being entered according to the command, a timer configured to measure an operation time of the idle mode; and a control circuit configured to compare the operation time and a reference time and control a state of a power control operation for at least one semiconductor device in the idle mode based on a result of comparison.

According to one or more example embodiments, a method of operating a memory, may include: obtaining a command to put the memory in an idle mode; initiating the idle mode based on the command; measuring an operating time of the idle mode starting when the idle mode is initiated; comparing the operating time and a reference time at which enabling a power control operation saves power; and based on the operating time exceeding the reference time, enabling the power control operation for the memory.

Details of example embodiments are included in the following detailed description and the accompanying drawings.

According to example embodiments, one or more of the following effects may be achieved.

According to example embodiments of the present disclosure, it is possible to efficiently control the power consumption of a memory device by comparing an operation time in an idle mode and a reference time and controlling a state of a power control operation for at least one semiconductor device in the idle mode based on a result of comparison. In addition, it is possible to more efficiently control the power consumption of the memory device by adaptively changing the reference time based on temperature information identified by various manners while the memory device is operated. Accordingly, embodiments herein implement a solution to a technical problem in the realm of computer memory.

Effects of the present disclosure are not limited to the aforementioned effects, and other unstated effects may be clearly understood by those skilled in the art from the attached claims.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 is a block diagram for illustrating a memory system according to one or more example embodiments;

FIG. 2 is a block diagram showing a memory device according to one or more example embodiments;

FIG. 3 is a block diagram showing a memory device according to one or more example embodiments;

FIG. 4 is a diagram for illustrating a process of determining a reference time according to one or more example embodiments;

FIG. 5 is a diagram for illustrating dynamic body bias and power gating depending on a state of a power control operation according to one or more example embodiments;

FIG. 6A is a diagram for comparing and illustrating states of power control operations according to one or more example embodiments;

FIG. 6B is a diagram for comparing and illustrating states of power control operations according to one or more example embodiments;

FIG. 6C is a diagram for comparing and illustrating states of power control operations according to one or more example embodiments;

FIG. 7A is a diagram for illustrating a reference time changed depending on a temperature according to one or more example embodiments;

FIG. 7B is a diagram for illustrating a reference time changed depending on a temperature according to one or more example embodiments;

FIG. 7C is a diagram for illustrating a reference time changed depending on a temperature according to one or more example embodiments;

FIG. 8A is a diagram for illustrating a process of controlling a state of a power control operation based on a temperature identified based on different manners according to one or more example embodiments;

FIG. 8B is a diagram for illustrating a process of controlling a state of a power control operation based on a temperature identified based on different manners according to one or more example embodiments;

FIG. 9 is a flow chart illustrating a method of operating a memory device according to one or more example embodiments; and

FIG. 10 is a block diagram of a computing system including a memory device according to one or more example embodiments.

### DETAILED DESCRIPTION

Terms used in the example embodiments are selected from currently widely used general terms when possible while considering the functions in the present disclosure. However, the terms may vary depending on the intention of a person skilled in the art, precedents, the emergence of new technology, and the like. Further, in certain cases, there are also terms arbitrarily selected by the applicant, and in these cases, the meaning will be described in detail in the corresponding descriptions. Therefore, the terms used in the present disclosure should be defined based on the meaning of the terms and the overall context of the present disclosure, rather than the simple names of the terms.

Throughout the specification, when a part is described as “comprising or including” a component, it does not exclude another component but may further include another component unless otherwise stated. Furthermore, terms such as “. . . unit,” “. . . part,” and “. . . module” described in the specification mean a unit that processes at least one function or operation, which may be implemented as hardware, software, or a combination thereof.

Hereinafter, example embodiments of the present disclosure will be described in detail with reference to the accompanying drawings so that those of ordinary skill in the art to which the present disclosure pertains may easily implement them. However, the present disclosure may be implemented in multiple different forms and is not limited to the example embodiments described herein.

Hereinafter, example embodiments of the present disclosure will be described in detail with reference to the accompanying drawings.

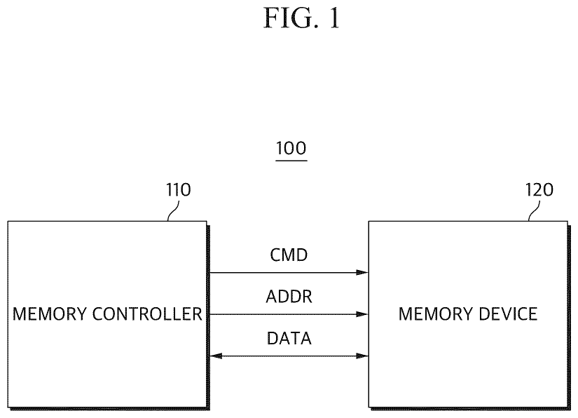

FIG. 1 is a block diagram for illustrating a memory system according to one or more example embodiments.

Referring to FIG. 1, a memory system 100 may include a memory controller 110 and a memory device 120. The memory controller 110 may control the overall operations of the memory device 120 by providing various signals to the memory device 120 through input and output lines. For example, the memory controller 110 may control a memory access operation of the memory device 120 such as reading and writing. The memory controller 110 may write data (DATA) on the memory device 120 or read the data (DATA) from the memory device 120 by providing a command (CMD) and an address (ADDR) to the memory device 120.

In this case, the command (CMD) that the memory controller 110 provides to the memory device 120 may include various commands such as ACT command, PRE command, REF command, CKE command, WRITE command, READ command, and MRS command. In addition, the address (ADDR) that the memory controller 110 provides to the memory device 120 may include various signals such as row address signal (ROW_ADDR), column address signal (COL_ADDR), and bank address signal (BANK_ADDR). The memory controller 110 may also provide the memory device 120 with various signals including control signal (CTRL) and data strobe signal (DQS), in addition to the command (CMD) and the address (ADDR).

The memory device 120 may output the data (DATA) requested to read by the memory controller 110 to the memory controller 110 or store the data (DATA) requested to write by the memory controller 110 in a memory cell. The memory device 120 may input and output the data (DATA) based on the command (CMD) and the address (ADDR). The memory device 120 illustrated in FIG. 1 may be a substantially identical device to a memory device described in other drawings below.

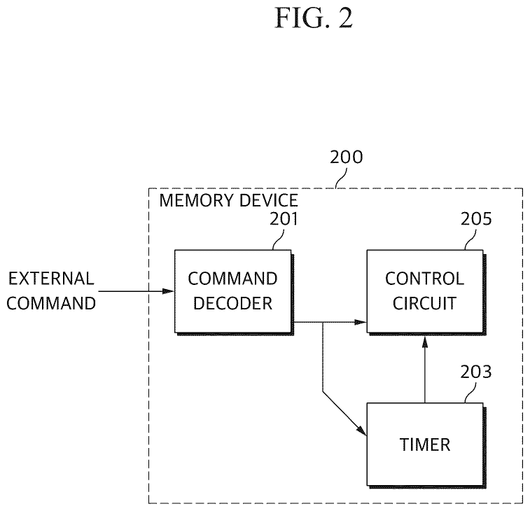

FIG. 2 is a block diagram showing a memory device according to one or more example embodiments. For convenience of illustration, FIG. 2 illustrates elements alone used to perform a method of operating a memory device 200. It may be understood by those of ordinary skill in the art to which the present disclosure pertains that the memory device 200 may further include other general-purpose elements in addition to the elements illustrated in FIG. 2.

A command decoder 201 may decode various commands obtained from the memory controller and an operation of the memory device 200 may be controlled based on various commands. For example, an operation mode of the memory device 200 may include an idle mode, a bank active mode, a write mode, a read mode, and a precharge mode.

When the memory device 200 enters into the idle mode based on a command obtained by the command decoder 201, a timer 203 may measure an operation time of the idle mode. For example, when the idle mode is entered as a PRE command (PRE CMD) is obtained by the command decoder 201, the operation time of the idle mode may be measured by the timer 203.

A control circuit 205 may compare the operation time measured by the timer 203 and a reference time and control a state of a power control operation for at least one semiconductor device based on a result of comparison. Here, the reference time may be managed through a table, and the state of the power control operation may be controlled as an enabled state or a disabled state based on the result of comparing the operation time and the reference time. For example, when the operation time is greater than or equal to the reference time, the control circuit 205 may control the power control operation in the enabled state, and when the operation time is less than the reference time, the control circuit 205 may control the power control operation in the disabled state.

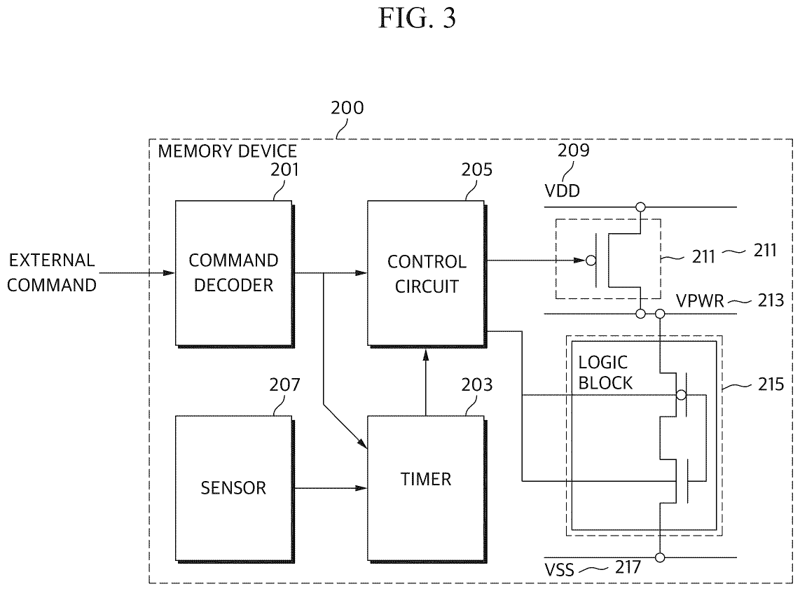

FIG. 3 is a block diagram showing a memory device according to one or more example embodiments. The descriptions of the memory device above may be applied to the memory device 200 of FIG. 3, and thus, duplicate contents refer to the descriptions above.

Referring to FIG. 3, the memory device 200 may further include a sensor 207, at least one semiconductor device 211 to which a power gating (PG) operation is applied, and a logic block 215 including at least one semiconductor device to which a dynamic body bias (DBB) operation is applied, in addition to the command decoder 201, the timer 203, and the control circuit 205. Here, the semiconductor device may include a P-channel metal oxide semiconductor (PMOS) device and an N-channel metal oxide semiconductor (NMOS) device.

The sensor 207 may sense at least one piece of information related to a situation where the memory device 200 operates. For example, the sensor 207 may sense a temperature in a situation where the memory device 200 operates. In addition, the sensor 207 may sense various pieces of information (for example, voltage, humidity, acceleration, impact, pressure, and the like).

When the PG operation is applied, the at least one semiconductor device 211 is controlled in a turned-off state, and thus, a route in which a source voltage VDD 209 is applied to the logic block 215 may be blocked. Specifically, when a power control operation is in the enabled state in the idle mode and the PG operation is applied, the at least one semiconductor device 211 connected between the source voltage VDD 209 and a voltage VPWR 213 may be controlled in the turned-off state. In other words, a supply of the source voltage VDD 209 to the logic block 215 may be blocked by the PG operation. Conversely, when the PG operation is not applied, the at least one semiconductor device 211 is controlled in a turned-on state, and thus, a route in which the source voltage VDD 209 is applied to the logic block 215 may not be blocked. Specifically, when a power control operation is in the disabled state in the idle mode and the PG operation is not applied, the at least one semiconductor device 211 connected between the source voltage VDD 209 and the voltage VPWR 213 may be controlled in the turned-on state. In other words, a supply of the source voltage VDD 209 to the logic block 215 may be connected.

The logic block 215 may be connected between the voltage VPWR 213 and a ground voltage 217. The logic block 215 is connected to the control circuit 205, and when a power control operation is in the enabled state, power consumption may be reduced in the logic block 215. The logic block 215 may include various elements including at least one semiconductor device in addition to the elements illustrated in FIG. 3 included in the memory device 200.

According to example embodiments, the DBB may be controlled by a block unit and the PG operation may be controlled by a bank unit. In this case, the bank unit is controlled by a bank address, and the block unit may correspond to a case other than the bank unit. For example, the DBB may be controlled by the block unit such as PRE CMD or ACT CMD, and the PG operation may be controlled by the bank unit such as PRE bank address or ACT bank address. Here, a bank may include a bank array, a bank sense amplifier, a bank row decoder, and a bank column decoder. Alternatively, according to another example embodiment, the DBB may also be controlled by the bank unit and the PG operation may be controlled by the block unit.

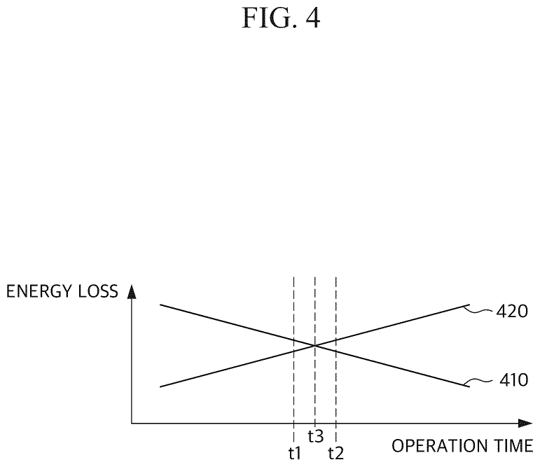

FIG. 4 is a diagram for illustrating a process of determining a reference time according to one or more example embodiments.

Referring to FIG. 4, an X axis may correspond to an operation time in the idle mode and a Y axis may correspond to an energy loss in the idle mode. A graph 410 may correspond to an energy loss by a current used for a switch toggle when a power control operation is in the enabled state, and a graph 420 may correspond to an energy loss by a leakage current when a power control operation is in the disabled state.

In this case, when a difference between the graph 410 and the graph 420 is within a predetermined range, a corresponding time period (that is, a t1 to t2 period) may correspond to a reference time period. In this case, the predetermined range may include a value greater than or equal to 0. In other words, a time when the graph 410 and the graph 420 intersect is included in the reference time period, and when, though a difference between the graph 410 and the graph 420 is present, the difference is within the predetermined range, a corresponding time may also be included in the reference time period. In this case, a time included in the reference time period may correspond to a reference time. In other words, a time included in the t1 to t2 period may correspond to the reference time. Time t3 when the graph 410 and the graph 420 intersect may correspond to the reference time.

In FIG. 4, since an energy loss by a power control operation is greater than an energy loss by a leakage current in a time period before time t1, the power control operation may be controlled in the disabled state in the time period before time t1. Further, in FIG. 4, since an energy loss by a power control operation is less than an energy loss by a leakage current in a time period after time t2, the power control operation may be controlled in the enabled state in the time period after time t2.

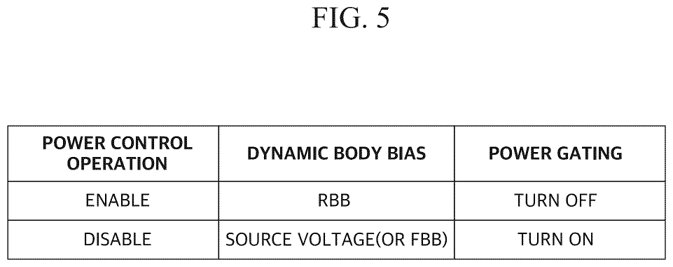

FIG. 5 is a diagram for illustrating dynamic body bias and power gating depending on a state of a power control operation according to one or more example embodiments.

Referring to FIG. 5, when a power control operation is in the enabled state, a reverse body bias (RBB) is applied to a semiconductor device to which the DBB operation is applied for energy efficiency, and a semiconductor device to which the PG operation is applied may be controlled in the turned-off state. When controlling in the turned-off state, a supply of the source voltage VDD to the logic block 215 may be blocked.

Meanwhile, when a power control operation is in the disabled state, a source voltage is applied to a semiconductor device to which the DBB operation is applied, or a forward body bias (FBB) is applied thereto for relatively high operation speed, and a semiconductor device to which the PG operation is applied may be controlled in the turned-on state. When controlling in the turned-on state, a supply of the source voltage VDD to the logic block 215 may be connected.

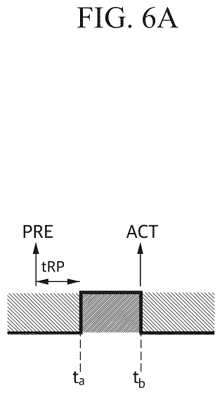

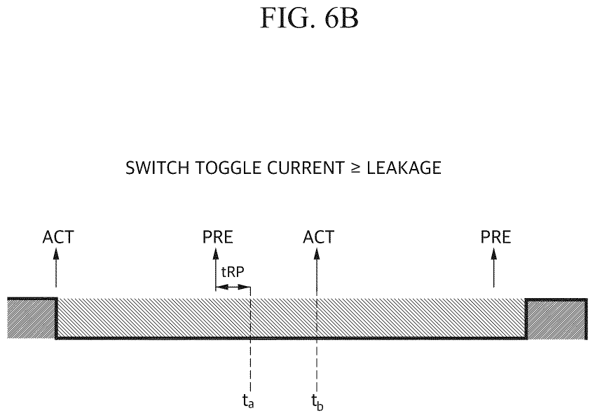

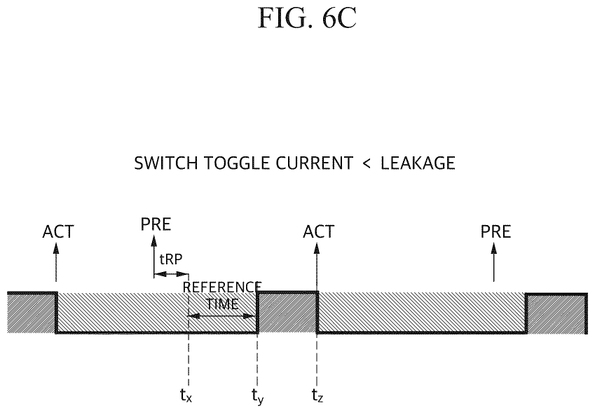

FIGS. 6A to 6C are diagrams for comparing and illustrating states of power control operations according to one or more example embodiments.

According to example embodiments, the memory device may enter into the idle mode or the precharge mode when power is supplied. The memory device may enter into the idle mode from the precharge mode when a precharge operation is completed. In other words, when a precharge command (PRE CMD) is obtained, a delay time tRP elapses, and a precharge operation is completed, the memory device may enter into the idle mode from the precharge mode. In addition, when an ACT command (ACT CMD) is obtained, the memory device may enter into the bank active mode from the idle mode. Alternatively, when a WRITE command (WRITE CMD) or a READ command (READ CMD) is obtained, the memory device may enter into the write mode or the read mode from the bank active mode. Then, when the PRE command is obtained, the memory device may enter into the precharge mode from the write mode or the read mode. Alternatively, when the PRE command is obtained, the memory device may also enter directly into the precharge mode from the bank active mode.

Referring to FIG. 6A, after the PRE command is obtained and the delay time tRP elapses, the memory device may enter into the idle mode at time tₐ and may enter into another mode from the idle mode when the ACT command is obtained at time t_{b}. In other words, the memory device may operate in the idle mode for a time tₐ to t_{b}. For reference, FIG. 6 is represented based on that a power control mode is in the enabled state for the time tₐ to t_{b}.

Referring to FIG. 6B, when it is determined that an energy loss by an operation current in a power control mode is greater than or equal to an energy loss by a leakage current for the time tₐ to t_{b} in which the memory device operates in the idle mode, the power control mode may be controlled in the disabled state for the time tₐ to t_{b} unlike FIG. 6A in order to effectively control power consumption.

Referring to FIG. 6C, after the PRE command is obtained and the delay time tRP elapses, the memory device may enter into the idle mode at time tₓ and may enter into another mode from the idle mode when the ACT command is obtained at time t_{z}. In other words, the memory device may operate in the idle mode for a time tₓ to t_{z}. The memory device may compare an energy loss by an operation current in a power control mode and an energy loss by a leakage current for the time tₓ to t_{z} operating in the idle mode. In this case, when a difference between the energy loss by the operation current and the energy loss by the leakage current is within a predetermined range, a difference between time t_{y} and time tₓ may be determined as the reference time according to the descriptions regarding FIG. 4. For example, a period of time tₓ to t_{y} in which an operation time is less than a reference time after the idle mode is entered at time tₓ is a period in which the energy loss by the operation current is greater than or equal to the energy loss by the leakage current, and for the period of time tₓ to t_{y}, the power control mode of the memory device may be controlled in the disabled state. For another example, a period of time t_{y} to t_{z} in which the memory device operates in the idle mode for the time t_{y} to t_{z} and the operation time is greater than or equal to the reference time is a period in which the energy loss by the operation current is less than the energy loss by the leakage current, and for the period of time t_{y} to t_{z}, the power control mode of the memory device may be controlled in the enabled state.

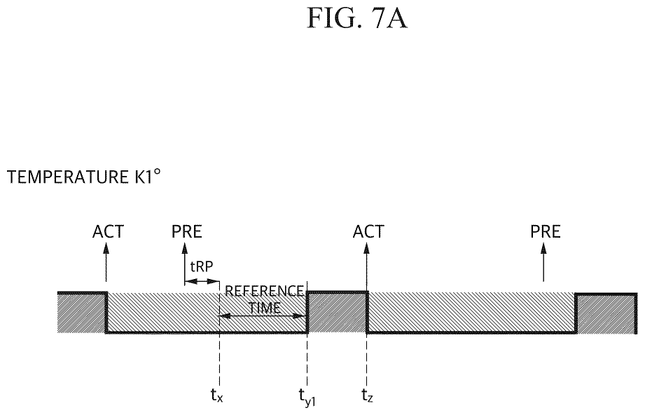

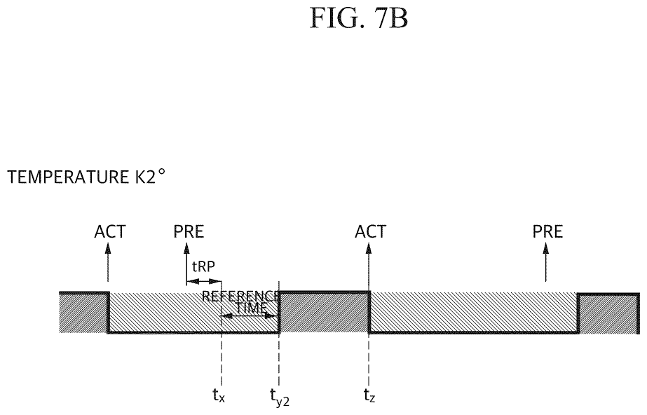

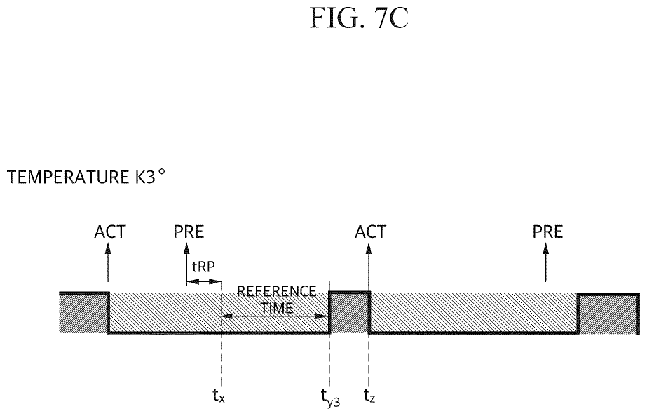

FIGS. 7A to 7C are diagrams for illustrating a reference time changed depending on a temperature according to one or more example embodiments.

Referring to FIGS. 7A to 7C, the memory device may obtain the PRE command and enter into the idle mode at time tₓ after the delay time tRP elapses and may enter into another mode from the idle mode when obtaining the ACT command at time t_{z}. In other words, in FIGS. 7A to 7C, the memory device may identically operate in the idle mode for the time tₓ to t_{z}. However, a reference time may be determined differently depending on a temperature in FIGS. 7A to 7C.

Referring to FIG. 7A, the memory device may compare an energy loss by an operation current in a power control mode and an energy loss by a leakage current for the time tₓ to t_{z} operating in the idle mode, and according to the descriptions above, time t_{y1}-tₓ may be determined as the reference time at temperature K1°. For a period of tₓ to t_{y} in which the operation time in the idle mode is shorter than the reference time, a power control operation may be controlled in the disabled state, and for a period of t_{y1} to t_{z} in which the operation time in the idle mode is longer than the reference time, the power control operation may be controlled in the enabled state.

Referring to FIG. 7B, the memory device may compare an energy loss by an operation current in a power control mode and an energy loss by a leakage current for the time tₓ to t_{z} operating in the idle mode, and according to the descriptions above, time t_{y2}-tₓ may be determined as the reference time at temperature K2°(>K1°). For a period of tₓ to t_{y2} in which the operation time in the idle mode is shorter than the reference time, a power control operation may be controlled in the disabled state, and for a period of t_{y2} to t_{z} in which the operation time in the idle mode is longer than the reference time, the power control operation may be controlled in the enabled state. In this case, when a temperature is relatively high, the reference time may be determined to relatively decrease. For example, comparing FIGS. 7A and 7B, the reference time (t_{y2}-tₓ) of FIG. 7B with a relatively high temperature may become less than the reference time (t_{y1}-tₓ) of FIG. 7A. In other words, in response to K2°>K1°, t_{y1}>t_{y2} may be controlled.

Referring to FIG. 7C, the memory device may compare an energy loss by an operation current in a power control mode and an energy loss by a leakage current for the time tₓ to t_{z} operating in the idle mode, and according to the descriptions above, time t_{y3}-tₓ may be determined as the reference time at temperature K3°(<K1°). For a period of tₓ to t_{y3} in which the operation time in the idle mode is shorter than the reference time, a power control operation may be controlled in the disabled state, and for a period of t_{y3} to t_{z} in which the operation time in the idle mode is longer than the reference time, the power control operation may be controlled in the enabled state. In this case, when a temperature is relatively low, the reference time may be determined to relatively increase. For example, comparing FIGS. 7A and 7C, the reference time (t_{y3}-tₓ) of FIG. 7C with a relatively low temperature may become greater than the reference time (t_{y1}-tₓ) of FIG. 7A. In other words, in response to K1°>K3°, t_{y3}>ty1 may be controlled.

According to example embodiments, the reference time may be changed adaptively by temperature, and the reference time may be changed in response to a change in temperatures during the operation of the memory device. In this case, the memory device may manage the reference time corresponding to a temperature with a lookup table, and a corresponding reference time may be applied based on temperature information.

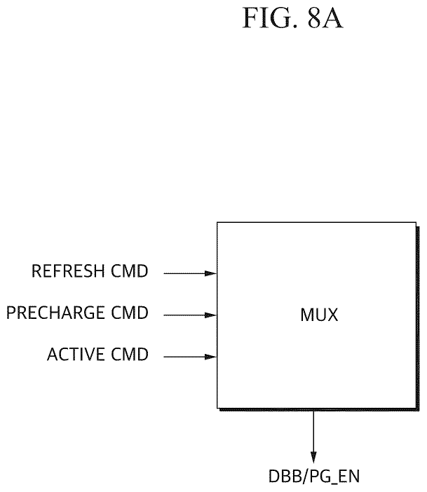

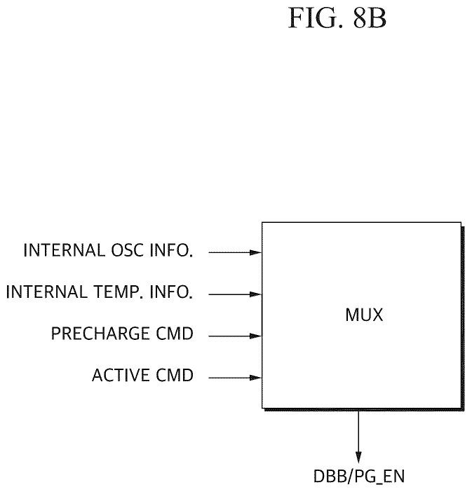

FIGS. 8A and 8B are diagrams for illustrating a process of controlling a state of a power control operation based on a temperature identified based on different manners according to one or more example embodiments.

Referring to FIG. 8A, a multiplexer (MUX) may obtain a refresh CMD, a precharge CMD, and an active CMD from the memory controller. Among the information obtained by the multiplexer, the refresh CMD has an inputted cycle that varies by temperature, and thus, temperature information may be identified based on the inputted cycle of the refresh CMD. Therefore, the multiplexer may determine an optimum time to control the state of the power control operation as the enabled state based on the identified temperature information.

Referring to FIG. 8B, the multiplexer may obtain internal oscillator information (“Internal OSC Info.”), (for example, frequency information), internal temperature information (“Internal Temp. Info.”), the precharge CMD, and the active CMD. Among these, the precharge CMD and the active CMD are information obtained from the memory controller, and the internal oscillator information (“Internal OSC Info.”) and the internal temperature information (“Internal Temp. Info.”) are information obtained from inside the memory device. The optimum time to control the state of the power control operation as the enabled state may be determined based on temperature information sensed by the sensor, and the reference time corresponding to the optimum time may be controlled by controlling frequencies of oscillation signals generated by an oscillator.

According to example embodiments, the memory device may determine a time to control a state of a power control operation as the enabled state or the disabled state by adaptively considering temperature information identified in various manners.

According to example embodiments, the multiplexer may be included in the timer or the control circuit of the memory device. Alternatively, when the control circuit is incorporated with the timer, the multiplexer may be included in the incorporated circuit.

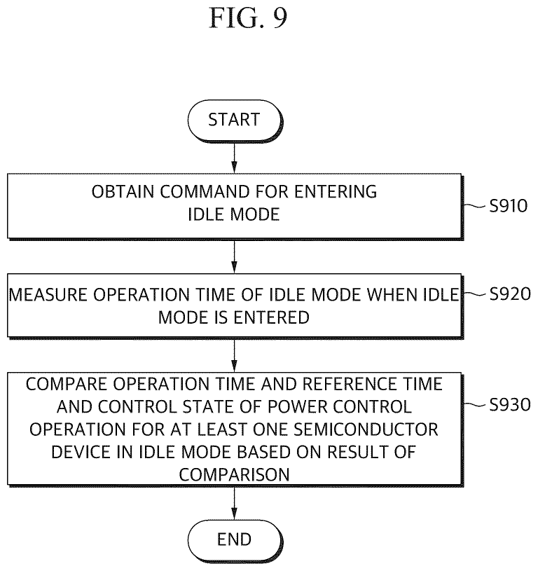

FIG. 9 is a flow chart illustrating a method of operating a memory device according to one or more example embodiments.

Referring to FIG. 9, in operation S910, the memory device may obtain a command for entering an idle mode. In this case, the memory device may obtain the precharge CMD (PRE CMD), and after the delay time tRP elapses, enter the idle mode. In other words, obtaining a command to put the memory in an idle mode.

In operation S920, the memory device may measure an operation time of the idle mode when the idle mode is entered. In this case, the timer of the memory device may measure the operation time of the idle mode from the moment when the idle mode is entered. In other words, measuring an operating time of the idle mode starting when the idle mode is initiated.

In operation S930, the memory device may compare the operation time and a reference time and control a state of a power control operation for at least one semiconductor device in the idle mode based on a result of comparison. Here, the power control operation may include a DBB operation and a PG operation for the at least one semiconductor device. In other words, comparing the operating time and a reference time at which enabling a power control operation saves power.

In this case, when the operation time is greater than or equal to the reference time, the power control operation for the at least one semiconductor device may be controlled in an enabled state. The enabled state may correspond to a state in which an RBB is applied to a semiconductor device to which the DBB operation is applied among the at least one semiconductor device and a semiconductor device to which the PG operation is applied among the at least one semiconductor device is controlled in a turned-off state. In other words, based on the operating time exceeding the reference time, enabling the power control operation for the memory.

Alternatively, when the operation time is less than the reference time, the power control operation for the at least one semiconductor device may be controlled in a disabled state. The disabled state may correspond to a state in which an FBB is applied or a source voltage is applied to a semiconductor device to which the DBB operation is applied among the at least one semiconductor device and a semiconductor device to which the PG operation is applied among the at least one semiconductor device is controlled in a turned-on state.

Here, the reference time may be determined based on a result of comparing a leakage current flowing in the idle mode and an operation current flowing when the power control operation is performed. Specifically, an energy loss by the leakage current may increase over time and the energy loss by the operation current may decrease over time. The reference time may be determined as a time in which a difference between the energy loss by the leakage current and the energy loss by the operation current corresponds to within a predetermined range. The descriptions regarding FIG. 4 may be applied for details.

In this case, when a different command (for example, refresh CMD) from the command is obtained from the memory controller, a cycle in which the different command is inputted may vary by temperature, and thus, the reference time may be determined based on temperature information identified based on the inputted cycle.

Alternatively, the reference time may be determined based on temperature information measured based on the sensor within the memory device regardless of the memory controller. Specifically, the reference time may be determined based on the temperature information identified by the sensor, and controlling the reference time may be performed by controlling frequencies of oscillation signals generated by the oscillator.

Meanwhile, the reference time may be determined to decrease as the temperature of the memory device increases and determined to increase as the temperature of the memory device decreases. With regard thereto, the descriptions above in FIGS. 7A to 7C may be applied.

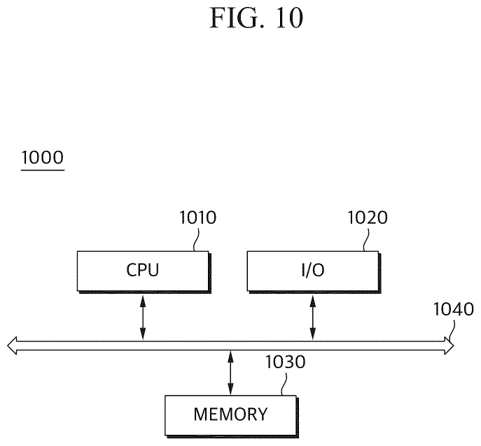

FIG. 10 is a block diagram of a computing system including a memory device according to one or more example embodiments. It may be understood by those of ordinary skill in the art to which the present disclosure pertains that a computing system 1000 may further include other general-purpose elements in addition to the elements illustrated in FIG. 10. The descriptions of the memory device above may be applied to a memory device 1030 included in the computing system 1000, and thus, duplicate contents refer to the descriptions above.

Referring to FIG. 10, the computing system 1000 may include a central processing unit (CPU) 1010, an input/output device (I/O) 1020, the memory device (MEMORY) 1030, and a data bus 1040.

The central processing unit 1010, the input and output device 1020, and the memory device 1030 may be combined with each other through the data bus 1040. The data bus 1040 may correspond to a path through which data are moved.

The central processing unit 1010 may include a control unit and an arithmetic and logic unit and may execute a program and process data. The central processing unit 1010 may be connected to a memory controller through the data bus 1040, and the central processing unit 1010 may also control the memory device 1030 through the memory controller.

The input/output device 1020 may include at least one input device which may include a mouse and a keyboard and may have data inputted and at least one output device which may include a monitor, a speaker, and a printer and may output data.

A memory system may include the memory controller and the memory device 1030, and the memory controller may control the memory device 1030. The memory device 1030, the memory controller, and the memory system may be implemented and operated according to various example embodiments. The memory device 1030 may transmit and receive data to and from the central processing unit 1010 and store data used for executing a program and/or instructions. Here, the memory device 1030 may be a volatile memory device such as dynamic random access memory (DRAM), synchronous dynamic random access memory (SDRAM), double data rate (DDR) DRAM, DDR SDRAM, low power double data rate (LPDDR) SDRAM, graphics double data rate (GDDR) SDRAM, Rambus dynamic random access memory (RDRAM), and static random access memory (SRAM). Alternatively, the memory device 1030 may also be implemented in a non-volatile memory device such as resistive random access memory (RRAM), phase change random access memory (PRAM), magnetoresistive random access memory (MRAM), ferroelectric random access memory (FRAM), and spin transfer torque magnetic random access memory (STT-RAM).

According to example embodiments, the computing system 1000 may be applied to a system such as a notebook, a desktop computer, a laptop computer, a smartphone, a tablet computer, an MP3 player, a personal digital assistant (PDA), a portable multimedia player (PMP), a digital television (TV), a digital camera, a portable game console, a navigation device, a wearable device, a virtual reality (VR) device, an augmented reality (AR) device, and a drone.

The memory system or the computing system according to the above-described example embodiments may include a processor, a memory for storing and executing program data, a permanent storage such as a disk drive, a communication port that communicates with an external device, and a user interface device such as a touch panel, a key, and a button. Methods implemented as software modules or algorithms may be stored in a computer-readable recording medium as computer-readable codes or program instructions executable on the processor. Here, the computer-readable recording medium includes a magnetic storage medium (for example, read-only memory (ROM), random-access memory (RAM), floppy disks, and hard disks) and an optically readable medium (for example, CD-ROM and digital versatile discs (DVDs)). The computer-readable recording medium may be distributed among network-connected computer systems, so that the computer-readable codes may be stored and executed in a distributed manner. The medium may be readable by a computer, stored in a memory, and executed on a processor.

The example embodiments may be represented by functional block elements and various processing steps. The functional blocks may be implemented in any number of hardware and/or software configurations that perform specific functions. For example, one or more example embodiments may adopt integrated circuit configurations, such as memory, processing, logic, and/or look-up table, that may execute various functions by the control of one or more microprocessors or other control devices. Similarly to that elements may be implemented as software programming or software elements, the example embodiments may be implemented in a programming or scripting language such as C, C++, Java, assembler, etc., including various algorithms implemented as a combination of data structures, processes, routines, or other programming constructs. Functional aspects may be implemented in an algorithm running on one or more processors. Further, the example embodiments may adopt the existing art for electronic environment setting, signal processing, and/or data processing. Terms such as “mechanism,” “element,” “means,” and “configuration” may be used broadly and are not limited to mechanical and physical elements. The terms may include the meaning of a series of routines of software in association with a processor or the like.

The above-described example embodiments are merely examples, and other embodiments may be implemented within the scope of the claims to be described later.

What is claimed is:

1. A memory device comprising:
a command decoder configured to obtain a command;
a timer configured to measure an operation time of an idle mode based on the idle mode being entered according to the command; and
a control circuit configured to:
compare the operation time and a reference time; and
control a state of a power control operation for at least one semiconductor device in the idle mode based on a result of the comparing.

2. The memory device of claim 1, wherein the control circuit is further configured to control the power control operation for the at least one semiconductor device in an enabled state based on the operation time being greater than or equal to the reference time.

3. The memory device of claim 2, wherein the control circuit is further configured to control the power control operation for the at least one semiconductor device in a disabled state based on the operation time being less than the reference time.

4. The memory device of claim 1, wherein the power control operation comprises a dynamic body-bias (DBB) operation and a power gating (PG) operation for the at least one semiconductor device.

5. The memory device of claim 1, wherein the reference time is determined based on a result of comparing a leakage current flowing in the idle mode and an operation current flowing during performance of the power control operation.

6. The memory device of claim 5,
wherein an energy loss by the leakage current increases over time and the energy loss by the operation current decreases over time, and
wherein during the reference time, a difference between the energy loss by the leakage current and the energy loss by the operation current is within a predetermined range.

7. The memory device of claim 5, wherein, based on a different command from the command being obtained from a memory controller, the reference time is determined based on temperature information identified based on a cycle in which the different command is inputted.

8. The memory device of claim 5, wherein the reference time is determined based on temperature information measured within the memory device regardless of a memory controller.

9. The memory device of claim 5, wherein the reference time is determined to decrease as a temperature increases and determined to increase as the temperature decreases.

10. The memory device of claim 2, wherein in the enabled state, a reverse body bias is applied to a first semiconductor device to which a dynamic body-bias (DBB) operation is applied among the at least one semiconductor device, and a second semiconductor device to which a PG operation is applied among the at least one semiconductor device is controlled in a turned-off state.

11. The memory device of claim 3, wherein in the disabled state, a forward body bias is applied or a source voltage is applied to a first semiconductor device to which a dynamic body-bias (DBB) operation is applied among the at least one semiconductor device, and a second semiconductor device to which a PG operation is applied among the at least one semiconductor device is controlled in a turned-on state.

12. A method of operating a memory device, the method comprising:
obtaining a command for entering an idle mode;
measuring an operation time of the idle mode based on the idle mode being entered; and
comparing the operation time and a reference time and controlling a state of a power control operation for at least one semiconductor device in the idle mode based on a result of comparison.

13. The method of claim 12, wherein the controlling the state of the power control operation includes controlling the power control operation for the at least one semiconductor device in an enabled state based on the operation time being greater than or equal to the reference time.

14. The method of claim 13, wherein the controlling the state of the power control operation includes controlling the power control operation for the at least one semiconductor device in a disabled state based on the operation time being less than the reference time.

15. The method of claim 12, wherein the reference time is determined based on a result of comparing a leakage current flowing in the idle mode and an operation current flowing during performance of the power control operation.

16. The method of claim 15,
wherein an energy loss by the leakage current increases over time and the energy loss by the operation current decreases over time, and
wherein the reference time is determined as a time in which a difference between the energy loss by the leakage current and the energy loss by the operation current corresponds to within a predetermined range.

17. The method of claim 15, wherein, based on a different command from the command being obtained from a memory controller, the reference time is determined based on temperature information identified based on a cycle in which the different command is inputted.

18. The method of claim 15, wherein the reference time is determined based on temperature information measured within the memory device regardless of a memory controller.

19. The method of claim 15, wherein the reference time is determined to decrease as a temperature increases and determined to increase as the temperature decreases.

20. A memory system comprising:
a memory device; and
a memory controller configured to control the memory device, wherein the memory device comprises:
a command decoder configured to obtain a command;
based on an idle mode being entered according to the command, a timer configured to measure an operation time of the idle mode; and
a control circuit configured to compare the operation time and a reference time and control a state of a power control operation for at least one semiconductor device in the idle mode based on a result of comparison.
